(19) United States
(12) Patent Application Publication
(10) Pub. No.: US 2010/0070341 A1
(43) Pub. Date: Mar. 18, 2010

(54) METHOD FOR THE FOLLOW-UP AND BEHAVIOR ASSESSMENT OF PARKS OF ATM TERMINALS BY MEANS OF STATISTICAL ANALYSES AND/OR GENERATION OF GRAPHICS OF UPDATED INDICATORS

(75) Inventors: Priscila TELES DA SILVA, Sao Paulo (BR); Natâlia MOURÅO SANSONI, Sao Paulo (BR); Nicolau AMADOR GALVÂO, Santo Amaro Sâo Paulo (BR); Lina YOSHIDA, Vila Clementino Sao Paulo (BR); Gisele DOS SANTOS RIBEIRO, Jardim Sâo Paulo (BR); Ivana CROCCI DE SOUZA, Vila Olimpia (BR); Jefferson ALVES, Bandeirantes Sorocaba Sâo Paulo (BR)

Correspondence Address: CANTOR COLBURN, LLP, 20 Church Street, 22nd Floor, Hartford, CT, 06103, US

(73) Assignee: TECNOLOGIA BANCARIA S.A., Barueri (Sao Paulo) (BR)

(21) Appl. No.: 12/499,313

(22) Filed: Jul. 8, 2009

(30) Foreign Application Priority Data
Jul. 11, 2008 (BR) PI 0802545-2

(51) Int. Cl. G06Q 10/00; G06Q 40/00; G06Q 50/00

(52) U.S. Cl. 705/10; 705/11

(57) ABSTRACT

The “METHOD FOR THE FOLLOW-UP AND BEHAVIOR ASSESSMENT OF PARKS OF ATM TERMINALS BY MEANS OF STATISTICAL ANALYSES AND/OR GENERATION OF GRAPHICS OF UPDATED INDICATORS” is related, more specifically, to a method prominently developed so that the outsourcing clients, owners of networks managed by other companies, such as banks and other companies which utilize ATM terminals, are enabled to perform a follow-up and assessment of the behavior of their parks of ATM terminals by means of statistical analyses and/or the generation of graphics of updated indicators within the shortest period of time possible, thus providing conditions for the making of strategic and operational decisions based on information supplied on-line.

### TECHNICAL FIELD OF THE INVENTION

The present invention is related to a method, prominently developed in order that the outsourcing clients, owners of networks managed by other companies, such as banks and other companies which utilize ATM terminals, are capable of performing a follow-up and assessment of the behavior of their parks of ATM terminals by means of statistical analyses and/or the generation of graphics of updated indicators within the least amount of time possible, thus providing conditions for the making of strategic and operational decisions based on pieces of information provided on-line.

### BRIEF DESCRIPTION OF THE RELATED ART

As is known by the professionals involved in this specific area, nowadays, the systems generate reports which are, in the vast majority of the times, intuitive and, therefore, not precise—these reports being presented as conventional spreadsheets, which display a focus exclusively skewed towards the generations of these mentioned reports and in accordance with the multiple platforms utilized.

Besides that, the generated reports only show previous activities and errors already made, without existing the possibility of establishing an anticipated measure so that the occurrences may be avoided or the actions may improve the forwarding and the speed of the information, that is, the aforementioned reports function with reactive actions in the proposal of information for the outsourcing clients.

Another aspect of great importance is the fact that, until then, there had not been complete trust for collecting data for the spreadsheet—previously, the data were collected without an established parameter for precision, besides which the gathering of the aforementioned data was made by a single determined area.

### DETAILED DESCRIPTION OF THE INVENTION

Aiming at providing the consumer market with improvements, the inventor has created and developed, after countless investigations, this “METHOD FOR THE FOLLOW-UP AND BEHAVIOR ASSESSMENT OF PARKS OF ATM TERMINALS BY MEANS OF STATISTICAL ANALYSES AND/OR GENERATION OF GRAPHICS OF UPDATED INDICATORS”, which ought to stand before the consumer market, attaining complete success in its field of action, due to the fact that it presents a method especially developed to follow up the quality of the service rendered by the administrating company of the parks of ATM terminals, featuring a unique tool with centralized information, making information available within shorter periods of time, besides providing a visual follow-up of the behavior of the products and services, enabling for the updated information to be compared to the historic behavior, establishing alerts where there are alterations in behavior, improving the analysis of the pieces of information which will allow for the making of strategic and operational decisions based on the information provided on-line - said decisions to be more agile and actions to be proactive for the improvement of the processes. The method in questions has been developed utilizing the concepts of Business Intelligence (BI) and Business Activity Monitoring (BAM), with the objective of enabling its users to know, follow up, and assess the behavior of the main products and services by means of visual resources utilized for the presentation of indicators grouped in four modules via dashboards, as follows:

1) Availability (Historic and On-line)—Ensures the follow-up of the Points of Capture, operated by the administrating company, supplying information pertinent to the availability of the terminals in order for their account holders to be able to carry out transactions. Main indicator: availability from the point of view of utilization by the end-user of the network;

2) Calls—Allows for the follow-up of the processes of Technical and Operational Catering of the open calls and sorted out by the administrating company. Main indicator: Performance of the ATM network—Metrics: volume of calls per point of capture;

3) Status of the On-line PC and Factors of Unavailability, History—has the purpose of presenting on-line the Points of Capture unavailable for each group of financial transaction, status of communication lines, and operation of each equipment. Main indicators: On-line Status of each Point of Capture and On-line Status of the ATM network;

4) Financial transactions and Transactional Occurrences—Offers qualitative and quantitative information pertinent to the performed transactions on the ATM terminals. Main indicator: Performance of the ATM networks—Metrics: volume of successful transactions on each terminal;

5) Operational Efficiency—Allows for the follow-up of the productivity and efficiency of the operators of technical and operational calls. Main indicator: Performance of the operators—Metrics: quantity of actions performed.

The tools and the methodology involved in the conception and development of this method are:

Methodology for the Management of Projects: PMI/PMBoK

Process of Software Development: RUP

Implementation tool: Panorama Suite

Data base: Oracle and SQL Server, and aggregated services (Integration Services, Reporting Services, Notification Services, Analysis Services)

Versioning tool: Rational Clearcase

Documenting tool: Word

Tool for modeling: Visio

The impacts obtained by the applicant on the networks of ATM terminals are:

The elimination of the use of reports in files sent to banks. With this method, the information is accessed via Web, with visual resources which provide ease and flexibility in the generation of graphics, the creation of new views with information presented in accordance with the necessity of the client, comparison of indicators, relationship and traceability between the pieces of information of the four modules, among others;

The pieces of information contained in the modules of the method are updated within the smallest period of time possible, during the 24 hours of the day, which enables the client to follow up the levels of services rendered by the administrating company at any given moment;

The transparency in the quality of the service rendered;

Competitive differential in the conquest of new businesses, potentialized by the efficacy and transparency of information which are brought by the tool into the Financial Institutions where the administrating company performs the management of their ATM networks;

Moreover, some reactions are foreseen, which are denominated operational impacts, as follows:

Significant decrease in the length of time for making the information available. Dynamism and simplicity in the detection of problems and increase in the proactivity of the resolution.

In the company, the application of this method implies in following up the quality of the service rendered with more expeditiousness and in increasing the level of trust deposited by their clients.

The application of this method also provides operational gains, allowing for more expeditiousness in decision-making, which has resulted in an increase in the efficiency of the field task forces, maintenance of high indexes of availability and reduction of the costs of operations.

The method claimed by the applicant will provide the administrating company with a competitive differential and greater possibility of presenting to their clients, in a more effective and transparent way, the quality of their services rendered in the management of ATM networks. The aforementioned method also opens doors to new business opportunities which follow the strategy of the company of being recognized as the extension of the ATM networks of the banks. In the technological aspect, the project has provided the creation and the establishment of good market practices, with tools and methodologies that are well thought of, making it more attractive and alluring to the market.

In spite of the invention being detailed, it is important to understand that the very invention does not limit its application to the detail and steps described herein. The invention is capable of other modalities and of being put in practice or executed within a variety of modes. It must remain understood that the terminology utilized herein is for the finality of description and not that of limitation.

What is claimed is:

1. A “METHOD FOR THE FOLLOW-UP AND BEHAVIOR ASSESSMENT OF PARKS OF ATM TERMINALS BY MEANS OF STATISTICAL ANALYSES AND/OR GENERATION OF GRAPHICS OF UPDATED INDICATORS”, of a method specially developed for the follow-up of the quality of the service rendered by the administrating company of the parks of ATM terminals, presenting a unique tool with centralized information, providing information within shorter periods of time, besides providing for a visual follow-up of the behavior of the products and services, making it possible for the comparison between the current information and the historic behavior, establishing alerts where there are alterations in the behavior, improving the analysis of the information which will allow for strategic and operational decisions to be made based upon information supplied on-line, said decisions being more agile and the actions proactive for the improvement of the processes, being characterized by the fact of presenting a method developed from the concepts of Business Intelligence (BI) and Business Activity monitoring (BAM), with the purpose of allowing its users to know, accompany, and assess the behavior of the main products and services by means of visual resources utilized for the presentation of indicators grouped in four modules via dashboards, as follows: 1) Availability (Historic and On-line)—Ensures the follow-up of the Points of Capture, operated by the administrating company, supplying information pertinent to the availability of the terminals in order for their account holders to be able to perform transactions. Main indicator: availability from the point o view of utilization by the end-user of the network; 2) Calls—Allows for the follow-up of the processes of Technical and Operational Catering of the open calls and sorted out by the administrating company. Main indicator: Performance of the ATM network—Metrics: volume of calls per point of capture; 3) Status of the On-line PC and Factors of Unavailability, History—has the purpose of presenting on-line the unavailable Points of Capture for each group of financial transaction, status of communication lines and operation of each equipment. Main indicators: On-line Status of each Point of Capture and On-line Status of the ATM network; 4) Financial Transactions and Transactional Occurrences—offers qualitative and quantitative information pertinent to the transactions performed on the ATM terminals. Main indicator: Performance of the ATM networks—Metrics: Volume of successful transactions on each terminal; 5) Operational Efficiency—Allows for the follow-up of productivity and efficiency of the operator of Technical and Operational calls. Main indicator: Performance of the operators—metrics: quantity of actions performed.

2. A “METHOD FOR THE FOLLOW-UP AND BEHAVIOR ASSESSMENT OF PARKS OF ATM TERMINALS BY MEANS OF STATISTICAL ANALYSES AND/OR GENERATION OF GRAPHICS OF UPDATED INDICATORS”, in accordance with claim 1, characterized by the fact that it presents a methodology for the Management of Projects of the PMI/PMBoK type.

3. A “METHOD FOR THE FOLLOW-UP AND BEHAVIOR ASSESSMENT OF PARKS OF ATM TERMINALS BY MEANS OF STATISTICAL ANALYSES AND/OR GENERATION OF GRAPHICS OF UPDATED INDICATORS”, in accordance with claim 1, characterized by the fact that it presents a process of software development of the URP type.

4. A “METHOD FOR THE FOLLOW-UP AND BEHAVIOR ASSESSMENT OF PARKS OF ATM TERMINALS BY MEANS OF STATISTICAL ANALYSES AND/OR GENERATION OF GRAPHICS OF UPDATED INDICATORS”, in accordance with claim 1, characterized by the fact that it presents an implementation tool of the Panorama Suite type.

5. A “METHOD FOR THE FOLLOW-UP AND BEHAVIOR ASSESSMENT OF PARKS OF ATM TERMINALS BY MEANS OF STATISTICAL ANALYSES AND/OR GENERATION OF GRAPHICS OF UPDATED INDICATORS”, in accordance with claim 1, characterized by the fact that it presents a data base: Oracle and SQL Server, and aggregated services (Integration Services, Reporting Services, Notification Services, Analysis Services).

6. A “METHOD FOR THE FOLLOW-UP AND BEHAVIOR ASSESSMENT OF PARKS OF ATM TERMINALS BY MEANS OF STATISTICAL ANALYSES AND/OR GENERATION OF GRAPHICS OF UPDATED INDICATORS”, in accordance with claim 1, characterized by the fact that it presents a versioning tool of the Rational Clearcase type.

7. A “METHOD FOR THE FOLLOW-UP AND BEHAVIOR ASSESSMENT OF PARKS OF ATM TERMINALS BY MEANS OF STATISTICAL ANALYSES AND/OR GENERATION OF GRAPHICS OF UPDATED INDICATORS”, in accordance with claim 1, characterized by the fact that it presents a documenting tool of the Word type.

8. A “METHOD FOR THE FOLLOW-UP AND BEHAVIOR ASSESSMENT OF PARKS OF ATM TERMINALS BY MEANS OF STATISTICAL ANALYSES AND/OR GENERATION OF GRAPHICS OF UPDATED INDICATORS”, in accordance with claim 1, characterized by the fact that it presents a tool for modeling of the Visio type.
